(19) United States
(12) Patent Application Publication
(10) Pub. No.: US 2015/0069212 A1
(43) Pub. Date: Mar. 12, 2015

(54) Inflatable Inverse Concrete Coil Form

(71) Applicant: Jeffrey Marc Mason, Gilbert, AZ (US)

(72) Inventor: Jeffrey Marc Mason, Gilbert, AZ (US)

(21) Appl. No.: 14/483,715

(22) Filed: Sep. 11, 2014

Related U.S. Application Data
(60) Provisional application No. 61/876,628, filed on Sep. 11, 2013.

(51) Int. Cl. B28B 7/00

(52) U.S. Cl. CPC B28B 7/0029
USPC 249/63

(57) ABSTRACT

A system designed to create the inverse shape of an object inside of wet concrete until hard, using and inflatable form. The inflatable inverse concrete coil form has the advantage of lower cost, can be reused, and has the ability to create shapes that would be impossible to make with ridged forms, or in limited space. The system advances the practical abilities of concrete by gaining its entire form structure through internal forces, and uses liquid as a ballast to achieve neutral buoyancy against the float force in wet cement.

### CROSS-REFERENCE TO RELATED APPLICATIONS

This is a non-provisional application of provisional patent application No. 61/876,628, filed on Sep. 11, 2013, and priority is claimed thereto.

### STATEMENT REGARDING FEDERALLY SPONSORED RESEARCH OR DEVELOPMENT

Not applicable.

### BACKGROUND

Concrete is one of the world's most common building materials. Its uses can be traced back over thousands of years. Its high compression strength properties and long lifespan provide a staple for modern society in buildings, roads, and infrastructure.

To reach its final state, concrete goes through a curing process. Water is mixed with cement to create a chemical reaction. While in this liquid state, the concrete can be molded or placed into molds to control the shape and location of the concrete, until curing has been achieved. Most forms are focus on creating the outside edge of the structure, where the cement is placed inside of the form until hardens into one continues piece of concrete. After it has cured, the outer form is removed which leaves the desired shape of cement.

While simple in concept, the mastery of cement can be a lifelong pursuit. Understanding different mix rations, additives, and curing conditions can determine the final performance and strength of the product. While the cured state may be the main performance that is measured, the short time while the mixture is in its liquid form has much different properties and performance. The wet state of concrete is much less understood beyond general slump tests, but understanding these temporary properties allows for new method of forms to be used.

### SUMMARY OF PRESENT INVENTION

The Inflatable Inverse Concrete Form is designed to create the inverse shape of the inflated shape within concrete while in its wet state. As the concrete cures, the properties within the cement change also. Therefore the design must be able to account for those changes until the mixture has cured and the surrounding concrete gains its own structural properties and is able to support the surrounding shape of the form.

One key benefit of using an inflatable inverse form as opposed to traditional forms is the ability to deflate the form. This allows the inflatable form to be removed from openings or access points that are smaller than the size of the form it creates inside, and to form non linear shapes.

The structural strength of the inverse form is opposite from traditional forms. Traditionally, exterior supports are needed to keep concrete inside of a form and prevent the form from moving under pressure. The strength from the form in the inflatable inverse form is opposite, coming from the inside of the inflatable pushing out. The pressure and weight of the concrete is fighting to collapse the space within.

When an object in wet concrete displaces the specific volume of space, it creates an upward force often referred to as float force. To overcome this, the inverse inflatable concrete coil form has the ability to add and subtract liquid from inside of the form to act as ballast. The weight of the liquid offsets the up float force to create neutral buoyancy.

While the use of the system is not limited to a coil design, the coil design does demonstrate the abilities of being able to create a very complex shape using this method in concrete work.

### DESCRIPTION OF THE DRAWINGS

FIG. 1 displays the general shape of the inflatable inverse concrete coil form when pressurized, oriented so the air and liquid valves of the unit are at the top.

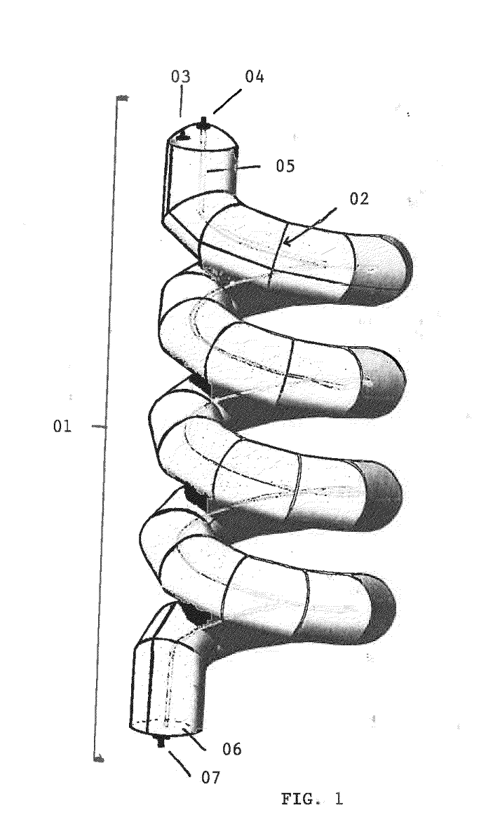

FIG. 2 displays the top portion of the inflatable forms and the valves used for inflating the form. The liquid valve has an internal tube attached which runs from the top of the form down to the lowest point in the form. It is used to add pressure and weight to the form using liquids such as water, and allows the form to be filled from the bottom of the form going up. It also allows the liquid to be suctioned back up the internal tube once the concrete has hardened. The other valve does not have any internal tube attached, and is used for inflating the form with air.

### DETAILED DESCRIPTION

The present invention is a system for creating an inflatable concrete coil form within cement. In FIG. q the shape of the form [01] is achieved by the seams [02] which have been design to be the specific shape of the form. The seams are sealed to allow the unit to hold pressure independently. The final design of the different sections of the form and the location of the seams will determine the final shape of the form once the unit becomes pressurized. This allows the form to gain structural properties for that shape without the use of exterior supports or bracing to achieve a final shape.

The form is inflated using two different methods. The first is an air valve [03]. The air valve allows the form to be inflated and deflated using air pressure. This is helpful in placing unit before the pour, and also allows the ability to add pressure to the system without adding additional weight. The second method to inflate the form is with a liquid valve [04]. A liquid valve allows liquid to be added or removed from inside of the form. One main difference with liquid and air pressure is the weigh that it gives to the overall form. By adding a liquid as ballast to the inside of the form, the form is able to gain neutral buoyancy. This helps the system overcome the properties of float force in wet concrete.

The liquid valve is attached to an internal tube [05] Which travels inside of the form down to the lowest point [06]. If the form is being used for an above ground where there will be access to the lowest point, then a gravity drain [07] can he installed to allow the liquid to drain after the concrete becomes hard. If the lowest point is not able to be accessed, then the liquid can be removed at the top valve.

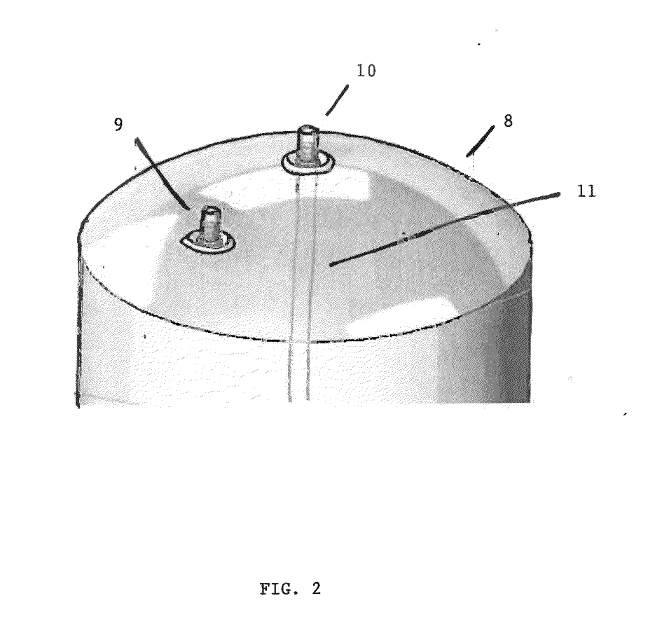

In FIG. 2 a close-up portion of the inflatable form [8] can better illustrate the air valve

and the liquid valve [10] and internal tube [11].

1. A system, compromising of an inflatable form designed to create the inverse shape of that form within wet cement until dry;

2. The system of claim 1, wherein, the desired product is the shape of the form itself.

3. The system of claim 1, wherein the shape of the form is non-linier.

4. The system of claim 1, wherein the shape of the form is achieved by the seams in the sections of the material and the pressure within.

5. The system of claim 1, wherein the shape of the form is not altered by outside objects or forces.

6. The system of claim 1, wherein the inflatable form can be removed after the concrete has become hard.

7. The system of claim 6, wherein the inflatable form can be deflated by removing the air and liquids from within, to break the bond with the concrete.

8. A system compromising of an inflatable form able to hold either liquid, or air, or a combination of both to create the pressure from within;

9. The system of claim 8, wherein a liquid can be added to act as ballast to counterbalance the float force of the inflatable form in wet cement.

10. The system of claim 8, wherein the water can be removed by a drain placed at the lowest point of the inflatable form.

11. The system of claim 8, wherein the pressure inside the inflatable form can be held independently without additional connections.

12. A system compromising of an internal tube that runs from the top of the form to the lowest point in the form.

13. The system of claim 12, wherein the internal tube is attached to the liquid valve on the inside of the form.

14. The system of claim 12, wherein the internal tube allows the form to be filled or emptied with liquid from the lowest point of the form.
